(19) United States
(12) Patent Application Publication
(10) Pub. No.: US 2025/0239815 A1
(43) Pub. Date: Jul. 24, 2025

(54) HIGH FREQUENCY CABLE COUPLER

(71) Applicant: Amphenol Corporation, Wallingford, CT (US)

(72) Inventor: Marc Robert Charbonneau, Bedford, NH (US)

(73) Assignee: Amphenol Corporation, Wallingford, CT (US)

(21) Appl. No.: 19/028,014

(22) Filed: Jan. 17, 2025

Related U.S. Application Data
(60) Provisional application No. 63/623,983, filed on Jan. 23, 2024.

(51) Int. Cl. H01R 13/6473; H01R 13/502

(52) U.S. Cl. CPC H01R 13/6473; H01R 13/502

(57) ABSTRACT

Compact cable couplers connecting cables of different wire gauges without disturbing electrical performances up to very high frequencies. Each cable coupler has a pair of conductive elements with first and second contact portions on opposite ends terminating wires of first and second cables. A housing encloses the conductive elements, including the cable attachments. A conductive layer extends from the first cable to the second cable and conforms to underlying surfaces. The housing has regions of lower dielectric constant adjacent the cable attachments. Parameters of the cable coupler in each of multiple portions may be selected to provide a matched impedance through the coupler. Such a coupler enables small diameter cables to make dense connections to a connector, while larger diameter cables provide low loss routing to a remote location, enabling high density signal connections with high signal integrity at frequencies high enough to support 224 Gbps.

### CROSS REFERENCE TO RELATED APPLICATION

This patent application claims priority to and the benefit of U.S. Provisional Patent Application Ser. No. 63/623,983, filed on Jan. 23, 2024, and entitled “HIGH FREQUENCY CABLE COUPLER,” which is hereby incorporated herein by reference in its entirety.

### FIELD

This patent application relates generally to interconnection systems, such as those including cables and electrical connectors.

### BACKGROUND

Electronic systems are assembled from multiple interconnected components. Often, components are mounted to printed circuit boards (PCBs), which provide both mechanical support for the components and conductive structures that deliver power to the components and provide signal paths between components attached to the PCB.

Sometimes PCBs are joined with electrical connectors. The connectors provide a separable interface such that the PCBs in a system can be manufactured at different times or in different locations, yet simply assembled into a system. A known arrangement for joining several printed circuit boards is to have one printed circuit board serve as a backplane. Other printed circuit boards, called “daughterboards” or “daughtercards,” may be connected through the backplane.

A backplane is a printed circuit board onto which many connectors may be mounted. Conducting traces in the backplane may be electrically connected to signal conductors in the connectors so that signals may be routed between the connectors. Daughtercards may also have connectors mounted thereon. The connectors mounted on a daughtercard may be plugged into the connectors mounted on the backplane. In this way, signals may be routed among the daughtercards through the backplane.

Connectors may also be used in other configurations for interconnecting printed circuit boards. Sometimes, one or more smaller printed circuit boards may be connected to another larger printed circuit board. In such a configuration, the larger printed circuit board may be called a “motherboard” and the printed circuit boards connected to it may be called daughterboards. Also, boards of the same size or similar sizes may sometimes be aligned in parallel. Connectors used in these applications are often called “stacking connectors” or “mezzanine connectors.”

In some scenarios, components may be separated by a longer distance than can be connected reliably via traces in a PCB. Cables may be used to route signals between components because cables can be routed through curving paths where it would be difficult to install a rigid PCB or can be manufactured with less signal loss per inch than a PCB. Cables with larger diameter wires may have less signal loss than those with smaller diameter wires.

Cables provide signal paths with high signal integrity, particularly for high frequency signals, such as those above 40 Gbps using an NRZ or PAM4 protocol. Each cable has one or more signal conductors, each of which is surrounded by a dielectric material. The insulated conductors are in turn is surrounded by a conductive layer. A protective jacket, often made of plastic, may surround these components. The jacket or other portions of the cable may include fibers or other structures for mechanical support.

One type of cable, referred to as a “twinax cable,” is constructed to support transmission of a differential signal and has a balanced pair of signal wires, which are embedded in dielectric material and encircled by a conductive layer. The conductive layer is usually formed using foil, such as aluminized Mylar. The twinax cable can also have a drain wire. Unlike a signal wire, which is generally surrounded by a dielectric, the drain wire may be uncoated so that it contacts the conductive layer at multiple points over the length of the cable.

Cables may be terminated with connectors, forming a cable assembly. The connectors may plug into mating connectors that are in turn connected to the components to be connected or may mate directly to a PCB or other substrate. At an end of the cable, where the cable is terminated to a connector or other terminating structure, different length segments of the protective jacket, dielectric and foil may be removed, leaving portions of the signal wires and the drain wire (if present) and foil shield exposed at the end of the cable. These conductors may be attached to a connector or other terminating structure. The signal wires may be attached to conductive elements serving as mating contacts in the connector. The drain wire or foil shield may be attached to a ground conductor in the terminating structure. In this way, any ground return path may be continued from the cable to the terminating structure.

To receive the connector of a cable assembly, a connector, called an “I/O connector” may be mounted to a PCB, usually at an edge of the PCB. That connector may be configured to receive a plug at one end of a cable assembly, such that the cable is connected to the PCB through the I/O connector. The other end of the cable assembly may be connected to another electronic device.

Cables have also been used to make connections within the same electronic device. For example, cables have been used to route signals from an I/O connector to a processor assembly that is located at the interior of the PCB, away from the edge at which the I/O connector is mounted. In other configurations, both ends of a cable may be connected to the same PCB or to different PCBs within the same enclosure. The cables can be used to carry signals between components mounted to the PCB near where each end of the cable connects to the PCB with less signal loss than if the signals were routed through traces within the PCBs.

### SUMMARY

Aspects described herein relate to high frequency cable couplers and electronic systems thereof.

Some embodiments relate to a cable coupler. The cable coupler may include a pair of conductive elements, each of the pair of conductive elements comprising a first contact portion, a second contact portion opposite the first contact portion, and an intermediate portion between the first contact portion and the second contact portion; a cable comprising a pair of wires, each of the pair of wires comprising a mounting end disposed between the pair of conductive elements and attached to the first contact portion of a respective one of the pair of conductive elements; and a housing holding the pair of conductive elements, the housing comprising a first material having a first dielectric constant, and a second material disposed between the mounting ends of the pair of wires of the cable, the second material having a second dielectric constant less than the first dielectric constant.

Some embodiments relate to a cable coupler. The cable coupler may include a conductive element comprising a first contact portion, a second contact portion opposite the first contact portion, and an intermediate portion between the first contact portion and the second contact portion, the first contact portion comprising a first notch having a first width configured for a first wire of a first diameter to attach thereon, the second contact portion comprising a second notch having a second width configured for a second wire of a second diameter to attach thereon, the second diameter different from the first diameter; and a housing holding the conductive element.

Optionally, the housing comprises a first material having a first dielectric constant, and a second material disposed adjacent the mounting end of the wire; and the second material has a second dielectric constant less than the first dielectric constant.

Optionally, the second material is air.

Optionally, the second material extends along the mounting end of the wire of the cable by a length that is in the range of 0.5 mm to 2 mm.

Optionally, the cable coupler includes a conductive layer bounding the housing.

Optionally, for the pair of conductive elements: the first contact portions are separated from each other by a first distance; the second contact portions are separated from each other by a second distance; and the second distance is greater than the first distance.

Optionally, for the pair of conductive elements: the intermediate portions are separated from each other by a third distance; and the third distance is less than the first distance.

Optionally, for the pair of conductive elements: each conductive element comprises a transition portion between the intermediate portion and the second contact portion; and the transition portions jog away from each other.

Optionally, the second material has a width substantially equal to the third distance.

Optionally, each of the pair of conductive elements comprises broadsides and edges joining the broadside; and the pair of conductive elements are disposed in an edge-to-edge configuration.

Optionally, for the pair of conductive elements: the first contact portions comprise first edges facing each other; the second contact portions comprise second edges facing each other; the intermediate portions comprise third edges facing each other; the first edges are offset from respective third edges by a first width; the second edges are offset from respective third edges by a second width; and the second width is greater than the first width.

Optionally, the mounting ends of the pair of wires of the cable are welded to the first edges of the first contact portions of respective ones of the pair of conductive elements.

Optionally, the cable is a first cable; and the cable coupler comprises a second cable comprising a pair of wires, each of the pair of wires comprising a mounting end disposed between the pair of conductive elements and attached to the second edge of the second contact portion of a respective one of the pair of conductive elements.

Optionally, the second material of the housing is also disposed between the mounting ends of the pair of wires of the second cable.

Some embodiments relate to a cable coupler. The cable coupler may include at least one conductive element, each of the at least one conductive element comprising a first contact portion, a second contact portion opposite the first contact portion, and an intermediate portion between the first contact portion and the second contact portion; a housing at least partially enclosing the at least one conductive element; and a conductive layer conformably applied on the housing.

Optionally, the at least one conductive element is a pair of conductive elements; and the cable coupler further comprises: a first cable comprising a pair of first wires, each of the pair of first wires comprising a first mounting end disposed between the pair of conductive elements, the first mounting ends of the pair of first wires attached to respective ones of the first contact portions of the pair of conductive elements; and a second cable comprising a pair of second wires, each of the pair of wires comprising a second mounting end disposed between the pair of conductive elements, the second mounting ends of the pair of second wires, the second mounting ends of the pair of wires attached to respective ones of the second contact portions of the pair of conductive elements.

Optionally, the conductive layer is electrically connected to shields of the first and second cables.

Optionally, the housing comprises a first pocket disposed between the first mounting ends of the first cable and a second pocket disposed between the second mounting ends of the second cable; and the first pocket and second pocket have a smaller dielectric constant than rest of the housing.

Optionally, the first pocket and second pocket have the same dielectric constant.

Optionally, the first pocket and second pocket are filled with air.

Optionally, each of the first pocket and second pocket is a cuboid.

Optionally, the first pocket and second pocket have different dielectric constants.

Optionally, the first pocket has a first width and a first thickness; the second pocket has a second width and a second thickness; the second width is greater than the first width; and the second thickness is greater than the first thickness.

Optionally, the first pocket has a first length in the longitudinal direction; and the second pocket has a second length equal to the first length.

Optionally, the housing comprises a first portion enclosing the first contact portions of the pair of conductive elements and the first mounting ends of the first cable, and a second portion enclosing the second contact portions of the pair of conductive elements and the second mounting ends of the second cable; and the second portion of the housing is wider and thicker than the first portion of the housing.

Optionally, the housing encloses the first mounting ends of the first cable and the second mounting ends of the second cable; and the conductive layer comprises a first portion conforming to a perimeter of the first cable and a second portion conforming to a perimeter of the second cable.

Some embodiments relate to a cable assembly. The cable assembly may include a plurality of cable couplers, each of the plurality of cable couplers comprising: at least one conductive element, each of the at least one conductive element comprising a first contact portion, a second contact portion opposite the first contact portion, and an intermediate portion between the first contact portion and the second contact portion; and a housing at least partially enclosing the at least one conductive element; an electrical connector comprising a plurality of conductive elements, each of the plurality of conductive elements comprising a mating end, and a mounting end opposite the mating end; and a plurality of cables, each of the plurality of cables comprising at least one wire, each of the at least one wire comprising a first mounting end and a second mounting end opposite the first mounting end, wherein, for each of the plurality of cables: the first mounting end of the at least one wire is attached to respective first contact portion of the at least one conductive element of a respective one of the plurality of cable couplers; and the second mounting end of the at least one wire is attached to respective mounting end of respective conductive element of the plurality of conductive elements of the electrical connector.

Optionally, the plurality of cable couplers are aligned in a plurality of rows; and for each row, the cable couplers have a center-to-center distance no greater than 2.4 mm.

Optionally, the cable couplers in adjacent rows are aligned and have a center-to-center distance no greater than 2.0 mm.

Optionally, the plurality of cables are a plurality of first cables, each of the plurality of first cables comprises at least one wire of a first diameter; and the cable assembly comprises a plurality of second cables, each of the plurality of second cables comprises at least one wire of a second diameter greater than the first diameter, each of the at least one wire of the second diameter comprises a first mounting end attached to respective second contact portion of the at least one conductive element of a respective one of the plurality of cable couplers.

Optionally, the electrical connector is a first electrical connector; the cable assembly comprises a second electrical connector; and for each of the plurality of second cables, each of the at least one wire of the second diameter comprises a second mounting end terminated at the second electrical connector.

Some embodiments relate to a method of interconnecting a first cable of a first wire gauge and a second cable of second wire gauge different from the first gauge. The method may include providing at least one conductive element, each of the at least one conductive element comprising a first contact portion, and a second contact portion opposite the first contact portion; forming a housing to at least partially enclose the at least one conductive element; and applying a conductive layer on the housing.

Optionally, forming the housing comprises forming a first pocket filled with air between the first contact portions of the pair of conductive elements; and forming a second pocket filled with air between the second contact portions of the pair of conductive elements.

Optionally, the method comprises welding wires of the first cable to the first contact portion of the at least one conductive element; and welding wires of the second cable to the second contact portion of the at least one conductive element.

Optionally, the conductive layer is applied by shrinking a tube comprising an inner conductive layer with at last a portion of the housing disposed within the tube.

Optionally, shrinking the tube comprises applying heat to the tube.

These techniques may be used alone or in any suitable combination. The foregoing is provided by way of illustration and is not intended to be limiting.

### BRIEF DESCRIPTION OF DRAWINGS

The accompanying drawings may not be drawn to scale. In the drawings, each identical or nearly identical component that is illustrated in various figures is represented by a like numeral. For purposes of clarity, not every component may be labeled in every drawing. In the drawings:

FIG. 1 is a perspective view of an electronic system, including a cable coupler assembly configured to connect components with cables of different sizes, according to some embodiments.

FIG. 2 is a top, side perspective view of a board connector that may be used in the electronic system of FIG. 1.

FIG. 3 is a bottom, side perspective view of a cable connector for mating with the board connector of FIG. 2.

FIG. 4 is a top, side perspective view of the board connector of FIG. 2 receiving the cable connector of FIG. 3.

FIG. 5 is an exploded perspective view of a terminal assembly of the cable connector of FIG. 3, with an overmold hidden.

FIG. 6 is a perspective view of the cable coupler assembly of the electronic system of FIG. 1.

FIG. 7 is a perspective view of a cable coupler of the cable coupler assembly of FIG. 6.

FIG. 8 is a perspective view of the cable coupler of FIG. 7, with a conductive layer hidden and a housing shown in phantom, showing a pair of conductive elements with cables of different sizes attached to opposite ends.

FIG. 9 is a plan view of the cable coupler of FIG. 8, showing pockets between wires of the cables.

FIG. 10 is a perspective view of a cable assembly having a plurality of cable couplers of FIG. 7 disposed in an array, with a support member shown in phantom.

FIG. 11 is a simulated plot of S-parameters as a function of the frequency of signals transmitted through the cable coupler of FIG. 7.

FIG. 12 is a plot of Time Domain Reflectometer (TDR) impedance as a function of time when a signal is transmitted through the cable coupler of FIG. 7.

### DETAILED DESCRIPTION

The inventors have recognized and appreciated techniques for constructing high density electronic systems that provide high signal integrity up to very high frequencies. The inventors have recognized and appreciated that high speed systems, such as systems capable of operating at 112 Gb/s or 224 Gb/s or higher, may benefit from the use of more cables to transmit signals that are traditionally transmitted via traces on printed circuit boards. More cabled interconnects, however, may require a higher density of cabled interconnects. Further, the inventors have recognized and appreciated that where a large number of cables are terminated to a connector, the space occupied by cables that provide desirable signal integrity over long distances may limit how closely the terminals within the connector can be spaced, which in turn may limit signal density of the cable assembly and density of the electronic system using such a cable assembly.

With techniques as describe herein, small diameter cables may be terminated to a cable connector and may provide a high density of cabled interconnects. The small diameter cables may have wires serving as signal conductors of 28 AWG or smaller, such as 30 AWG or 32 AWG. These small diameter cables may be coupled to larger diameter cables, such as cables with wires serving as signal conductors of 27 AWG or larger, such as 26 AWG or 24 AWG. A cable coupler as described herein may enable a connection between the larger and smaller diameter cables without significant impact on electrical performance. Exemplary embodiments may provide a return loss through the coupler of −20 dB or less, for example. Smaller diameter cables may make a high density of connections to a connector or other termination structure for a cable assembly, such as a pitch of 2.5 mm per signal pair, while the larger diameter cables may route signals over long distances, such as distances of 6 inches or more, without significant loss.

The inventors have recognized and appreciated designs for compact cable couplers for interconnecting cables of different wire gauges without introducing discontinuities in electrical properties along signal transmission paths provided by these cables up to very high frequencies (e.g., 80 GHz or other frequencies as used to carry data at rates of 112 Gb/s or 224 Gb/s or higher). The couplers may be configured to support dense packing such that multiple such cable couplers may be packaged in a cable connector assembly, providing couplers that may be attached to multiple cables terminated to a high density connector.

A cable coupler may include one or more conductive elements, such as a pair of conductive elements configured to carry a pair of differential signals. Each conductive element may have a first contact portion and a second contact portion disposed on opposite ends and configured to be attached with cables of different wire gauges. The conductive elements and surrounding structure of the cable coupler may be configured to provide little or no detectable change in impedance between the smaller diameter cable and the larger diameter cable. One or more techniques may be used to provide little or no change in impedance. These techniques may include: different geometry of the conductive elements at the first contact portion, the second contact portion and an intermediate portion joining the first and second contact portions; an insulative housing holding the conductive elements with different effective dielectric constants in regions between and/or surrounding the first contact portion, the second contact portion and/or the intermediate portion; and a conductive layer over the housing applied so as to provide a desired separation from the conductive elements adjacent the first contact portion, the second contact portion and the intermediate portion.

In some embodiments, the first contact portions of the pair may be separated from each other by a first distance, which may be sized according to a first wire gauge (e.g., 32 AWG). The second contact portions of the pair may be separated from each other by a second distance, which may be sized according to a second wire gauge (e.g., 27 AWG). Each conductive element may have broadsides and edges joining the broadsides. The pair of conductive elements may be arranged to provide an impedance matching that of the cables, In the illustrated example, the conductive elements are in an edge-to-edge configuration in which an edge of one conductive element faces an edge of the other conductive element separated by a distance and a material that provides a desired impedance.

A pair of wires of a first cable of the first wire gauge may be reliably attached at opposed surfaces of the first contact portions of the pair of conductive elements. In the example illustrated, the wires are attached to edges of the contact portions. Similarly, a pair of wires of a second cable of the second wire gauge may be reliably attached at opposed edges of the second contact portions of the pair of conductive elements. With such an arrangement, changes of geometry at the cable attachments, which might otherwise cause changes of impedance that could impact signal integrity, may be reduced. Alternatively or additionally, such an attachment interface may reduce the amount of metal at the attachment interface, reducing the change of inductance relative to a conventional design in which a cable is soldered on a broadside of a signal conductor, which also reduces changes of impedance.

A housing may hold the pair of conductive elements, including the cable attachments. The inventors have recognized and appreciated that the dimensions of the housing may be sized to fit within a space defined by the cables. In some examples, the first cables may be arranged in a first array; the second cables may be arranged in a second array; and the cable couplers may be arranged in a third array to interconnect the first array of first cables and the second array of second cables. The dimensions of the third array may be substantially similar to the larger one of the first and second arrays such that the cable couplers can fit into the limited space in the system.

The inventors have recognized and appreciated techniques for providing high frequency cable couplers with a compact housing. The housing may be mostly made of a first material and have a second material disposed in selected locations. The second material may have a dielectric constant lower than that of the first material. The locations and materials may be configured so as to provide an impedance matching the impedance of other components of the systems (e.g., 85 ohm, 95 ohm, 105 ohm), without enlarging the dimensions of the housing, and therefore avoiding discontinuities that disrupt signal integrity along signal transmission paths. When the impedances are identical or close enough to not have an appreciable effect on electrical properties along the signal path, such as within ±3% variation or less, the impedances may be considered as being matched.

The housing may be formed of a dielectric material with a low dielectric constant, such as a relative dielectric constant less than 3. As a specific example, the dielectric constant may be 2.7, for example. Within the housing pockets of material may have a different dielectric constant. The pockets may have a lower dielectric constant. As a specific example, a first pocket may be filled with air, which may have a dielectric constant of about 1, for example. The first pocket may be disposed between the first contact portions of the pair of conductive elements. A second pocket filled with air and disposed between the second contact portions of the pair of conductive elements. The first pocket may be at least partially bounded by the smaller one of the first and second cables, and the second pocket may be at least partially bounded by the larger one of the first and second cables. In some embodiments, the second pocket may have a same length as the first pocket in the signal transmission direction, yet may be wider and/or deeper than the first pocket in other directions.

The cable coupler may have a conductive layer electrically connecting shields of the cables being connected. Such a conductive layer may partially or totally surround the housing of the cable coupled. In some examples, the conductive layer may be flexible and may conform to sides of the housing and have two portions extending to the first and second cables, respectively. In examples in which the wires of the cables are terminated to opposing surfaces of the conductive elements of the coupler (such as opposing edges in an edge-coupled configuration), the separation between the conductive structures carrying signals within the cable coupler and the grounded outer conductive layer may be dictated by the shape of the housing around the conductive elements. Such a configuration enables signal to ground spacing to be controlled by the configuration of the housing. As control of the signal to ground spacing controls variations in impedance, conforming the conductive layer to the housing enables accurate control over impedance through the cable coupler.

Alternatively or additionally, portions of the conductive layer may conform to the perimeters of the first and second cables, respectively. Two portions of the conductive layer, for example, may be electrically connected to shields of the first and second cables, respectively. Such a configuration may enable the cable coupler to make a connection that does not have an appreciable effect on electrical properties along the signal transmission paths up to very high frequencies, while satisfying the dimensional requirements according to the sizes of the cables. A conformal conductive layer may be applied, for example, as a coating or as a heat shrink tube with an inner conductive layer that is threaded around the cable coupler housing and a portion of each of the coupled cables and then shrunk to conform to those structures.

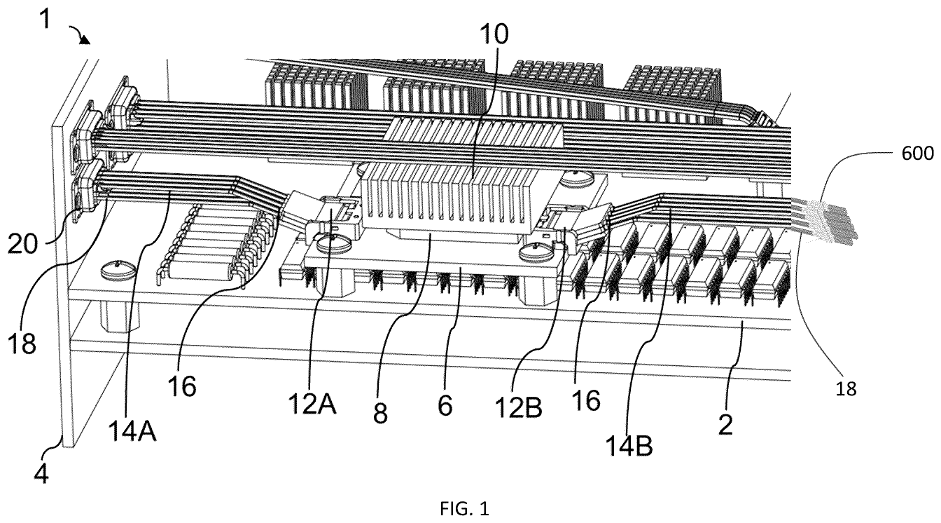

The foregoing principles are illustrated with an example, such as the electronic system 1 shown in FIG. 1. In the electronic system 1, a cabled connection is made between a connector 20 mounted to a panel 4 at the edge of a printed circuit board 2 (e.g., a motherboard), and a connector 12A mounted on a printed circuit board 6 (e.g., a daughterboard). As illustrated, daughterboard 6 may be mounted in a midboard region above the motherboard 2. The connector 12A may provide a low loss path for routing electrical signals between one or more components, such as component 8, mounted to daughterboard 6 and a location off the daughterboard 6. Component 8, for example, may be a processor or other integrated circuit chip. It should be appreciated that any suitable component or components on daughterboard 6 may receive or generate the signals that pass through the connector 12A.

In the illustrated example, the connector 12A couples signals to and from component 8 through the connector 20 mounted to the panel 4 of an enclosure. The connector 20 may be an I/O connector, which may mate with a transceiver terminating an active optical cable assembly or active electrical cable assembly that routes signal to or from another device. Panel 4 is shown to be orthogonal to motherboard 2 and daughterboard 6. Such a configuration may occur in many types of electronic equipment, as high speed signals frequently pass through a panel of an enclosure containing a printed circuit board and must be coupled to high speed components, such as processors or ASICS, that are farther from the panel than high speed signals can propagate through the printed circuit board with acceptable attenuation. Connectors may be used to couple signals between locations in the interior of a printed circuit board and one or more other locations, either internal or external to the enclosure.

In the example of FIG. 1, connector 12A mounted at the edge of daughterboard 6 is configured to support connections to an I/O connector 20. As can be seen, cabled connections may connect to other locations of the system. For example, there is a second connector 12B, making connections to daughterboard 6.

Cables 14A and 14B may electrically connect connectors 12A and 12B to locations remote from component 8 or otherwise remote from the locations at which connectors 12A or 12B are attached to daughterboard 6. In some embodiments, first ends 16 of the cables 14A and 14B may be connected to the connector 12A or 12B, and second ends 18 of the cables 14A may be connected to respective I/O connectors 20. Connector 20, however, may have any suitable function and/or configuration, as the present disclosure is not so limited. In some embodiments, higher frequency signals, such as signals above 112 Gbps, such as signals of 224 Gbps or higher in some examples, may be connected through cables 14A or 14B, which may otherwise be susceptible to signal losses at distances greater than or approximately equal to six inches.

Cables 14A may have a length that enables connector 12A to be spaced from second ends 18 at connector 20 by a first distance. In some embodiments, the first distance may be longer than a second distance over which signals at the frequencies passed through cables 14A could propagate along traces within motherboard 2 and daughterboard 6 with acceptable losses. In some embodiments, the first distance may be at least 6 inches, in the range of 1 to 20 inches, or any value within the range, such as between 6 and 20 inches. However, the upper limit of the range may depend on the size of motherboard 2 or the electronic system incorporating motherboard 2.

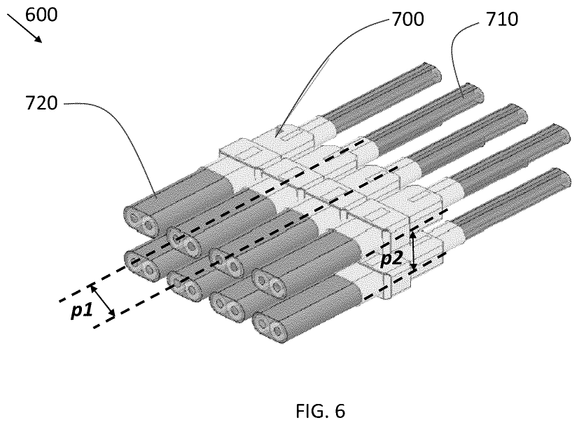

In some examples, connections may need to be made between locations that are spaced by a distance longer than the first distance over which signals could pass through cables 14A sized to terminate to connectors 12A and 12B without appreciable effects in electrical properties. Such connections may be made with cables having larger diameters than that of cables extending out of cable connectors (e.g., cables 14A, 14B), such that high density cable connectors may be used to fit many cables within limited space near electronic components (e.g., daughterboard 6) while larger cables may be used to route signals over longer distances without significant loss. Smaller cables may be connected to larger cables through cable couplers, which may be configured to introduce no appreciable discontinuities in electrical properties along signal transmission paths provided by these cables up to very high frequencies (e.g., 80 GHz), while satisfying the dimensional requirements according to the sizes of the cables. As a specific example, a cable coupler may provide less than −20 dB of insertion loss between a larger diameter and a smaller diameter cables over a frequency range of 0-80 GHz and with physical dimensions that fits on a pitch between 1 and 2.5 mm. In the illustrated example, cables 14B may have first ends 16 attached to connector 12B and second ends 18 attached to cable assembly 600 (see FIG. 6).

In some examples, connector 12A may be configured for mating to a daughterboard 6 or other PCB in a manner that allows for ease of routing of signals coupled through the connector. For example, an array of signal pads to which terminals of connector 12A are mated may be spaced from the edge of daughterboard 6 or another PCB such that traces may be routed out of that portion of the footprint in all directions, such as towards component 8.

As illustrated, connector 12A may include cables 14A aligned in multiple rows at first ends 16 and extending out of connector 12A. Such a configuration, or another suitable configuration selected for connector 12A, may result in relatively short breakout regions that maintain signal integrity in connecting to an adjacent component in comparison to routing patterns that might be required were those same signals routed out of an array with more rows and fewer columns.

As shown in FIG. 1, the connector 12A may fit within a space that might otherwise be unusable within electronic device 1. In this example, a heatsink 10 is attached to the top of processor or component 8. Heatsink 10 may extend beyond the periphery of processor 8. As heatsink 10 is mounted above daughterboard 6, there is a space between portions of heatsink 10 and daughterboard 6. However, this space has a height H, which may be relatively small, such as 5 mm or less, and a conventional connector may be unable to fit within this space or may not have sufficient clearance for mating. However, at least a portion of the connector 12A and other connectors of exemplary embodiments described herein may fit within this space adjacent to processor 8. For example, a thickness of a connector housing may be between 3.5 mm and 4.5 mm. Such a configuration uses less space on printed circuit daughterboard 6 than if a connector were mounted to printed circuit daughterboard 6 outside the perimeter of heatsink 10. Such a configuration enables more electronic components to be mounted to printed circuit to which a midboard connector (e.g., connector 12A) is connected, increasing the functionality of electronic device 1. Alternatively, the printed circuit board, such as daughterboard 6, may be made smaller, thereby reducing its cost. Moreover, the integrity with which signals pass from connector 12A to processor 8 may be increased relative to an electronic device in which a conventional connector is used to terminate cables 14A, because the length of the signal path through printed circuit daughterboard 6 is reduced.

While the embodiment of FIG. 1 depicts a connector connecting to a daughter card at a midboard location, it should be noted that connector assemblies of exemplary embodiments described herein may be used to make connections to other substrates and/or other locations within an electronic device.

As discussed herein, midboard connector assemblies may be used to make connections to processors or other electronic components. Those components may be mounted to a printed circuit board or other substrate to which the midboard connector might be attached. Those components may be implemented as integrated circuits, with for example one or more processors in an integrated circuit package, including commercially available integrated circuits known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores in one package such that one or a subset of those cores may constitute a processor. Such processors may process a large number of signals, such as more than 1,000 or more than 2,000, such that creating a compact electronic system may benefit from a high density of connections through connectors, such as connectors 12A and 12B. Though, a processor may be implemented using circuitry in any suitable format.

In the illustrated embodiment, the processor is illustrated as a packaged component separately attached to daughtercard 6, such as through a surface mount soldering operation. In such a scenario, daughtercard 6 serves as a substrate to which connector 12A is mounted. In some embodiments, the connector may be mated to other substrates. For example, semiconductor devices, such as processors, are frequently made on a substrate, such as semiconductor wafer. Alternatively, one or more semiconductor chips may be attached, such as in a flip chip bonding process, to a wiring board, which may be a multi-layer ceramic, resin or composite structure. The wiring board may serve as a substrate to which the connector is mounted.

Connectors 12A and/or 12B may be implemented by mating a board connector that may be mounted to daughterboard 6 with a cable connector that may have cables (e.g., cables 14A, 14B) extending therefrom.

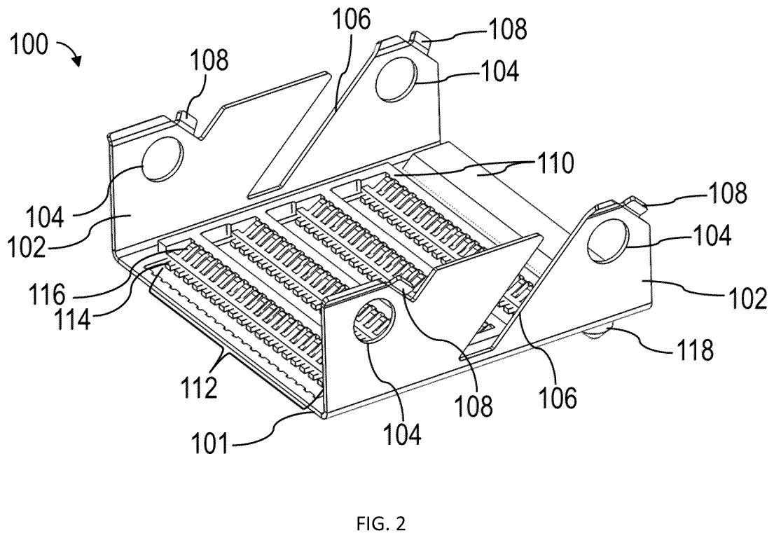

FIG. 2 is a perspective view of an exemplary board connector 100. As shown in FIG. 2, the board connector may comprise a unitary piece of material (e.g., metal), and may be formed at least partially by stamping and overmolding. As illustrated, the board connector 100 includes a terminal assembly including a base 101 and two wings 102. The base 101 is disposed in a first plane, while the two wings 102 extend from the base 101. In the illustrated embodiment, the wings 102 extend orthogonally from the base 101.

The board connector may include features that engage and position a cable connector. In the illustrated example, those features include a plurality of projection receptacles 104, with two projection receptacles 104 disposed on each wing 102 near the corner regions of the wings. Each wing 102 also includes a guide channel 106, which is inclined relative to the base 101 and has an open end opposite the base 101. The guide channel 106 may be angled relative to the base 101. The angle may be between 15 and 60 degrees, or between 30 and 55 degrees in some embodiments. FIG. 2, for example, illustrates the guide channel 106 angled at approximately 45 degrees relative to the base.

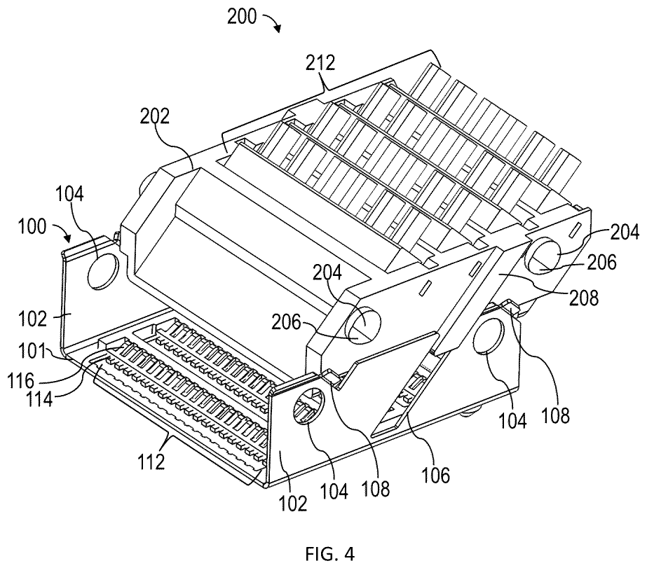

The wings may each include two lead-in tabs 108 associated with the projection receptacles 104. The function of the lead-in tabs 108 and projection receptacles 104 will be discussed further with reference to FIG. 4. According to some embodiments, as shown in FIG. 2, the board connector may include an alignment projection 118 configured to assist in aligning the board connector terminals with contact pads on a PCB or other substrate. The alignment projection 118 may be received in a corresponding hole in the PCB or other substrate to orient and align the board connector. Projection 118 may be used, for example, to position the board connector on a PCB prior to reflow soldering the terminals of the board connector to pads of the PCB.

The board connector 100 may include a plurality of terminals 112 associated with the base 101. The plurality of terminals 112 may be integrally formed with the base 101 during a manufacturing process where the terminals 112 are stamped from sheet metal. In the illustrated example, the terminals 112 are disposed in four rows. Each row may be configured to mate with a terminal subassembly of a mating cable connector.

Each terminal 112 may include a first portion 114 and a second portion 116. The first portion 114 may be disposed in the plane of the base 101, and may comprise tails configured for surface mounting to contact pads on an associated substrate (e.g., PCB). For example, the tails may each be configured to be soldered to a PCB with a solder reflow process. The second portion 116 may be disposed at an angle relative to the plane of the base 101. The second portion 116 may extend upwards away from the base 101 to form a contact tip for corresponding terminals of a cable connector. The second portions 116 may function as cantilevered beams configured to undergo elastic bending and provide a biasing spring force urging a corresponding cable connector away from the board connector when a cable connector is mated to the board connector 100. In some embodiments, the second portion 116 may be angled relative to the plane of the lower face of the base 101 at an angle between 15 and 45 degrees, for example. In the illustrated example of FIG. 2, the second portion 116 is angled between 20 and 30 degrees.

The board connector 100 may include a dielectric 110 overmolded on the plurality of terminals 112 and the base 101. The dielectric may be configured to physically support each of the terminals 112 relative to the base 101. Accordingly, the integrally formed plurality of terminals 112 may be physically and electrically severed from one another. In some embodiments, tie bars between the terminals 112 may be removed. Once the plurality of terminals 112 are electrically severed, the dielectric 110 may provide the sole physical support for the terminals 112 and may maintain their positions relative to the base 101. Accordingly, in some embodiments of a manufacturing process, a terminal assembly may be stamped, a dielectric 110 may be overmolded over the plurality of terminals 112 and a portion of the base 101, and at least a portion of the terminals 112 may be electrically severed from one another (e.g., by removing tie bars). Although each terminal assembly includes 76 terminals in the illustrated example, it should be appreciated that any number of terminals may be employed, as the present disclosure is not so limited.

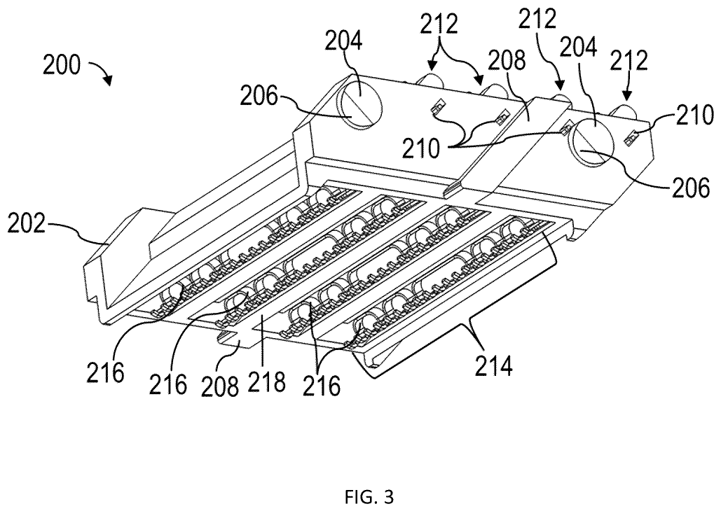

FIG. 3 is a perspective view of an exemplary embodiment of a cable connector 200. The cable connector 200 may include a connector housing 202. The connector housing 202 may include a plurality of projections 204. In particular, the connector housing 202 may have two projections 204 shown in FIG. 3, and two corresponding projections 204 on an opposing side of the connector housing 202. The projections 204 may be configured to engage projection receptacles (e.g., projection receptacles 104) formed in a board connector (e.g., board connector 100). The projections 204 may be configured to engage the projection receptacles 104 to resist movement of the cable connector 200 away from the board connector 100. Each of the projections 204 may include a lead-in 206 configured to enable the projections 204 to move past corresponding projection receptacles 104 when the cable connector is moved toward the board connector, as will be discussed further with reference to FIG. 4.

The connector housing 202 may include guides 208 disposed on opposite sides of the connector housing 202. The guides 208 may be angled relative to a bottom face 218 of the connector housing 202, which may sit parallel to a PCB or other substrate when the cable connector 200 is engaged with the board connector 100. The guides 208 may be angled at an angle relative to the bottom face 218. The guides 208 may be angled at an angle that matches that of guide channels 106. The angle, for example, may be between 15 and 60 degrees, such as at an angle between 30 and 50 degrees. The guides 208 may be received in corresponding guide channels 106 of the board connector 100 to restrict the relative movement of the cable connector 200 to a single axis (i.e., eliminating or reducing rotational axes). The connector housing 202 may be formed of a dielectric material (e.g., plastic), but the present disclosure is not so limited in this regard, and any appropriate material may be employed.

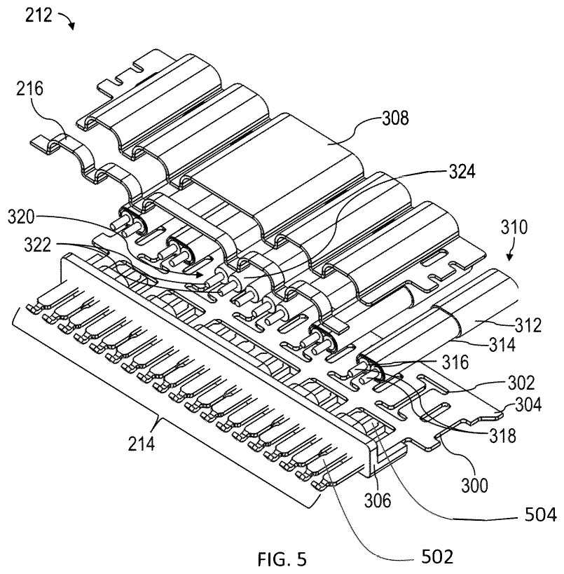

The connector housing 202 may be configured to receive a plurality of terminal assemblies 212. The terminal assemblies 212 may be received in slots arranged in rows, so that a plurality of terminals 214 may extend past the bottom face 218 at an angle relative to the bottom face. As illustrated, the terminal assemblies 212 may be angled at an angle relative to the bottom face 218. The terminal assemblies 212 may be angled at an angle that matches that of guides 208. The angle, for example, may be between 15 and 60 degrees, such as at an angle between 30 and 50 degrees. The terminal assemblies 212 may be configured to be retained in the connector housing 202 with retaining tabs 304 (shown in FIG. 5) that engage corresponding tab receptacles 210 formed in the connector housing 202. Each terminal assembly 212 may include a member 216 configured to connect ground terminals to reduce resonance modes. Although each terminal assembly includes 19 terminals and the connector housing accommodates four terminal assemblies for a total of 76 terminals in the illustrated example, it should be appreciated that any number of terminals and terminal assemblies may be employed, as the present disclosure is not so limited.

FIG. 4 is a perspective view illustrating the board connector 100 mating with the cable connector 200. As illustrated, the guides 208 of the cable connector housing 202 may be received in the guide channels 106 of the first and second wings 102 of the board connector 100. Accordingly, the movement of the cable connector 200 may be limited to movement along a single axis, where movement in a first direction moves the cable connector 200 close to the board connector 100 and movement in a second direction moves the cable connector 200 further away from the board connector 100. The axis of movement of the cable connector 200 may be parallel to the guides 208 and the guide channels 106, and in the illustrated example, is between 30 and 45 degrees relative to the base 101 of the board connector 100.

The lead-ins 206 of each of the projections 204 of the cable connector 200 may be aligned with the lead-in tabs 108 of the board connector 100. The lead-ins 206 and lead-in tabs 108 may have complementarily angled surfaces so that engagement between the lead-ins 206 and lead-in tabs 108 does not inhibit movement of the cable connector. When the lead-ins 206 engage the lead-in tabs 108, the first and second wings 102 of the board connector 100 may be elastically deformed outward away from the cable connector 200, so that the wings 102 of the board connector 100 may accommodate the width of the cable connector 200.

As the cable connector 200 continues to move closer to the board connector 100, the lead-ins 206 may engage the projection receptacles 104 to deform the wings 102 outward and to avoid capturing the projections 204 in the projection receptacles 104 when the cable connector 200 is moved in the first direction. Accordingly, the cable connector 200 may move freely in the first direction until the terminals 214 of the cable connector 200 contact the terminals 112 of the board connector 100.

Upon insertion of the cable connector 200 into the board connector 100, the terminals of the cable connector 200 may engage the second portions 116 of the terminal 112 of the board connector 100. As the second portions 116 may be disposed at an angle relative to the base 101, the second portions may elastically deform and generate biasing force urging the cable connector 200 in the second direction away from the board connector 100. Accordingly, when the insertion force is reduced or removed from the cable connector 200, the cable connector may move in the second direction under urging from the second portions 116 until the projections 204 are captured in the projection receptacles 104, thereby inhibiting further movement in the second direction. This process may accomplish a terminal wipe for effective electrical conduction, and provide a lower variation for a stub length of the terminals.

FIG. 5 is an exploded perspective view of an exemplary embodiment of a cable connector terminal assembly 212. The terminal assembly 212 may include a plurality of terminals 214 extending from a cable clamp plate 300. The plurality of terminals 214 and the cable clamp plate 300 may be stamped from a same piece of metal, such that the plurality of terminals and cable clamp plate were at one point integral. As illustrated, the terminal assembly 212 may include a dielectric 306 overmolded over the plurality of terminals 214 and a portion of the cable clamp plate 300. The dielectric 306 may be plastic material. The dielectric 306 may physically support the plurality of terminals 214. Accordingly, at least a portion of the plurality of terminals 214 may be physically separated from the cable clamp plate 300 (e.g., tie bars are removed) to electrically isolate the terminals. The dielectric 306 may be configured to maintain the relative positions of the terminals 214. The cable clamp plate 300 may include retaining tabs 304 configured to be received in corresponding tab receptacles 210 of the cable connector housing 202. Such an arrangement allows the terminal assembly to be reliably and accurately secured in a cable connector housing.

The cable clamp plate 300 may be configured to secure a plurality of cables 310 to the terminal assembly 212. In the illustrated example, the cables 310 is configured as drainless twinax cables. Techniques as described herein enable the twinax cables to be spaced with a relatively small pitch, such as a center-to-center spacing between 1 and 2.5 mm or between 1.5 and 2.5 mm, such as between 2.3 and 2.5 mm or 2.4 mm in some examples. Each cable 310 may include two cable conductors 318, each of which may be electrically and physically coupled to one or more of the terminals 214. Each of the cable conductors 318 may be surrounded by dielectric insulation 316, which may electrically isolate the cable conductors from one another. A shield 314, which may be connected to ground, may surround the cable conductors 318 and dielectric insulation 316. The shield 314 may be formed of a metal foil. The shield 314 may extend along a perimeter of the dielectric insulation 316. The shield 314 may be coupled to one or more contact tips of ground terminals of the terminals 214 through a compliant conductive member (e.g., member 308). Surrounding the shield may be an insulating jacket 312. Although a drainless twinax cable is shown in FIG. 5, other cable configurations may be employed, including those having more or less than two cable conductors (e.g., one cable conductor), one or more drain wires, and/or shields in other configurations, as the present disclosure is not so limited. For example, the cable clamp plate 300 may accommodate single conductor cables 320, which each include single conductors 322 surrounded by a single layer of dielectric insulation 324.

The conductors 318 of the cables 310 may be attached, such as by soldering or welding, to tails of the terminals 214 in the terminal assembly 212. The shields 314 of the cables may be electrically connected to the ground structures of the terminal assembly 212 via clamping.

The cable clamp plate 300 may include multiple strain relief portions 302. In the illustrated example, the strain relief portions 302 are defined by I-shaped slots or openings formed in the cable clamp plate 300, which may enable the cable clamp plate 300 to deform under clamping pressure securing the cables 310 to the cable clamp plate 300. Such an arrangement may reduce or eliminate the likelihood of the cable conductors 318 being crushed or otherwise altered by clamping force. In the illustrated example, a member 308 is configured to clamp the cables 310 to the cable clamp plate 300. The member 308 may be secured around the cables 310 by welding (e.g., laser welding), overmolding, or another appropriate process, once an appropriate clamping force (e.g., 100 lbs.) is applied to the metal plate.

The terminal assembly may include a member 216 configured to electrically interconnect ground terminals of the terminals 214. The member 216 may be laser welded or soldered to the ground terminals of the terminals 214 near the ends of the terminals 214. For example, the ground conductor may be no more than 1.97 mm from the ends of the terminals 214. Such an arrangement may reduce the quarter wavelength of standing resonance modes, thereby enabling the cable connector 200 to support higher frequencies without resonance mode interference.

FIG. 6 is a perspective view of the cable assembly 600 of the electronic system 1. The cable assembly 600 may include a plurality of cable couplers 700 disposed in multiple rows. Each cable coupler 700 may interconnect a first cable 710 of a smaller wire gauge, which may extend out of a high density connector such as connector 12B or cable connector 200, to a second cable 720 of a larger wire gauge, which may transmit signals for longer distance with less loss than the first cable 710. The first cables 710 may be arranged in a first array; the second cables 720 may be arranged in a second array; and the cable couplers 700 may be arranged in a third array to interconnect the first array of first cables 710 and the second array of second cables 720. The dimensions of the third array may be substantially similar to the second array such that the cable couplers 700 can fit into the limited space in the system. For example, when the first cable 710 and the second cable 720 have 32 AWG and 27 AWG respectively, a center-to-center distance p1 between two neighboring cable couplers 700 within each row may be no greater than 2.4 mm, and a center-to-center distance p2 between two neighboring couplers 700 aligned in adjacent rows may be no greater than 2.0 mm. Although two rows of cable couplers 700 are shown in FIG. 6 with each row having four cable couplers 700, it should be appreciated that the cable assembly 600 may include an array of cable couplers 700 disposed according to arrangement of a respective connector such as connector 12B or cable connector 200.

Though the segments of first cables illustrated in FIG. 6 extend in parallel from cable couplers 700, those cables may bend together as they approach a connector. Accordingly, the pitch between cables may be smaller at the cable connector terminating cables 710 than the pitch between cable couplers.

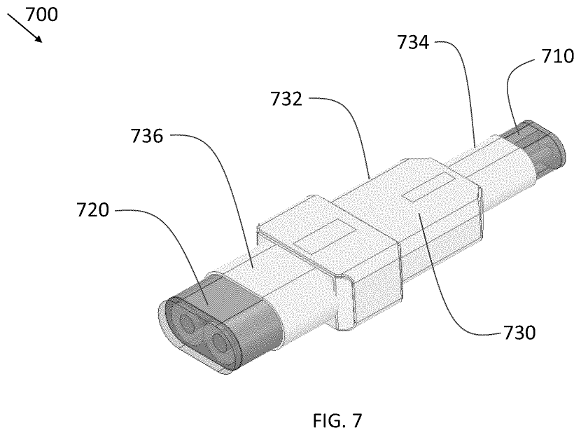

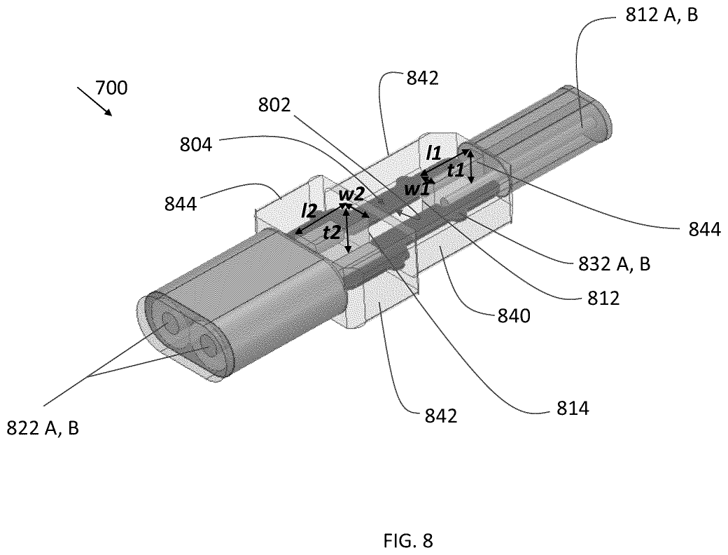

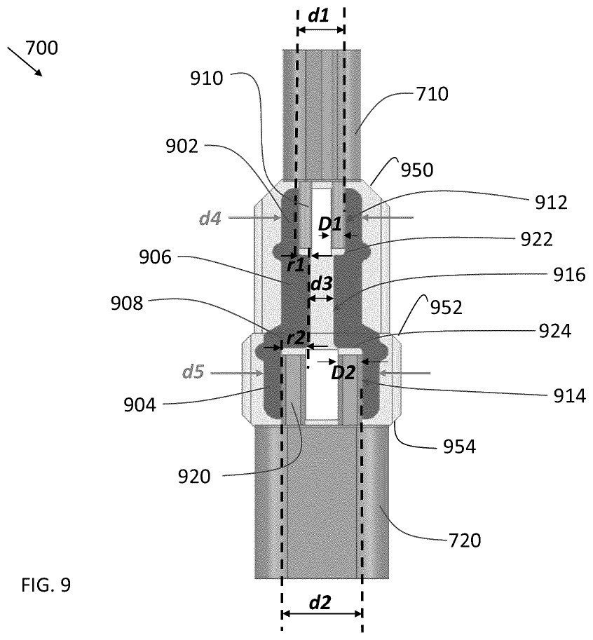

The cable couplers 700 are configured to fit in a space limited by the sizes of the cables while not have an appreciable effect on electrical properties along the signal transmission paths up to very high frequencies. FIGS. 7 and 8 show perspective views of the cable coupler 700. FIG. 9 is a plan view of the cable coupler 700. In this example, the cable coupler is configured to couple two drainless twinax cables with different wire sizes. As illustrated, the cable coupler 700 may include a pair of conductive elements 832A and 832B, a housing 840 holding the pair of conductive elements 832A and 832B, and a conductive layer 730 conformably applied to surfaces of the housing 840 and/or ends of the first cable 710 and the second cable 720. The conformal conductive layer may conform to ends of the cables to be coupled where the cable shield is exposed such that the conformal conductive layer 730 provides a continuous ground path from one cable shield to the other.

The pair of conductive elements 832A and 832B may be configured to interconnect the wires of first cable 710 of a smaller wire gauge to the wires of second cable 720 of a larger wire gauge. Each conductive elements 832A or 832B may include a first contact portion 902, a second contact portion 904 opposite the first contact portion, and an intermediate portion 906 between the first contact portion 902 and the second contact portion 904.

The conductive elements may be stamped and optionally may be formed into a configuration for termination to the wires of the first and second conductors with low impedance discontinuity. In this illustrated example, the conductive elements are made of a highly conductive metal, such as a copper alloy. The conductive elements are generally planar such as may result from stamping the conductive elements from a metal sheet. To provide a controlled impedance within the cable coupler, the spacing between the conductive elements may be established by the stamping. That spacing may be preserved, for example, by initially holding the conductive elements with one or more tie bars that are concurrently stamped from the sheet of metal. The conductive elements may be secured with a housing, which may be overmolded on the conductive elements after which, the tie bars may be severed. In the example illustrated, the wires of the cables are attached to edges of the conductive element, enabling the entire conductive element to be manufactured without any folding or other forming operations which might lead to imprecise positioning of features of the conductive elements.

The conductive elements may also be made with a configuration that facilitates connection of cables with little impedance change along the length of the conductive elements, even at frequencies up to 80 GHz. As illustrated in the example of FIG. 9, the first contact portion 902 may have a first notch 922 having a first width r1 configured for a first wire of the first cable 710 with a first diameter D1 to attach thereon. The second contact portion 904 may have a second notch 924 having a second width r2 configured for a second wire of the second cable 720 with a second diameter D2 to attach thereon. As illustrated, the first width r1 may be substantially similar to the first diameter D1; and the second width r2 may be substantially similar to the second diameter D2.

Each conductive element 832A or 832B may have broadsides 804 and edges 802 joining the broadsides 804. The first contact portions 902 may have first edges 912 facing each other. The second contact portions 904 may have second edges 914 facing each other. The intermediate portion 906 may have third edges 916 facing each other. The first edges 912 may be offset from respective third edges 916 by the first width r1 of the first notch 922. The second edges 914 may be offset from respective third edges 916 by the second width r2 of the second notch 924. As illustrated, the first cable 710 may have a first pair of wires 812A and 812B each having a first mounting end 910 attached to the first edge 912 of a respective first contact portion 902 at a respective first notch 922. The second cable 720 may have a second pair of wires 822A and 822B each having a second mounting end 920 attached to the second edge 914 of a respective second contact portion 904 at a respective second notch 924.

For the pair of conductive elements 832A and 832B, as illustrated in FIG. 9, the first contact portions 902 may be separated from each other by a first distance d1. Each conductive element 832A or 832B may have a transition portion 908 between respective intermediate portion 906 and second contact portion 904. The transition portions 908 of the pair may jog away from each other such that the second contact portions 904 may be separated from each other by a second distance d2 that is greater than the first distance d1. The intermediate portions 906 may be separated from each other by a third distance d3 that is less than the first distance d1. Outer edges of the first contact portions 902 may be separated from each other by a fourth distance d4 configured to be substantially similar to a size of the first cable 710. Outer edges of the second contact portions 904 may be separated from each other by a fifth distance d5 configured to be substantially similar to a size of the second cable 720.

The pair of conductive elements 832A and 832B may be made of metal or any other material that is conductive and provides suitable mechanical properties for conductive elements in an electrical connector. Phosphor-bronze, beryllium copper and other copper alloys are non-limiting examples of materials that may be used. The conductive elements may be formed from such materials in any suitable way, including by stamping and/or forming.

Although a pair of conductive elements configured for cables with pairs of wires are illustrated, it should be appreciated that a cable couple may have any suitable number of conductive elements configured for respective cables to attach thereon. For example, a cable couple may have one conductive element for a single ended cable, two or more pairs of conductive elements for cables having multiple pairs of wires, etc.

Referring to FIGS. 8 and 9, the housing 840 may be molded from one or more dielectric materials. The housing 840 may include a first material 842 having a first dielectric constant, and a second material 844 having a second dielectric constant that may be less than the first dielectric constant. The second material 844 may be selectively disposed between the pair of conductive elements 832A and 832B so as to balance impedance along the transmission paths. Without the second material 844, the pair of conductive elements 832A and 832B would need to be separated farther from each other to provide desired impedance, which may make the cable coupler too large to fit in the space limited by the sizes of the cables. Examples of suitable first materials include, but are not limited to, liquid crystal polymer (LCP), polyphenylene sulfide (PPS), high temperature nylon or polyphenylene oxide (PPO) or polypropylene (PP). In some examples, a material with a relative dielectric constant of 3 or less may be used. Examples of suitable second materials include air, and any suitable material having a desired dielectric constant, which may be less than the dielectric constant of the rest of the housing.

The second material 844 may be disposed between the first mounting ends 910 of the first cable 910, and/or the second mounting ends 920 of the second cable 920. As illustrated, the housing 840 may have a first pocket 812 disposed between the first mounting ends 910 of the first cable 910, and a second pocket 814 disposed between the second mounting ends 920 of the second cable 920. Although it is described that the first pocket 812 and the second pocket 814 are filled with the same second material 844, it should be appreciated that the first pocket 812 and the second pocket 814 may be filled with different materials that have dielectric constants less than the first dielectric constant of the first material 842. Moreover, while the rest of the housing is shown as a unitary material, in some examples, the housing in regions adjacent the first and/or second contact portions and/or the intermediate portions may be different to match the impedance in each of the portions.

The first pocket 812 and the second pocket 814 may be shaped and sized to provide a desired impedance along a signal transmission path through the cable coupler. As illustrated, the first pocket 812 may have a first length l1, a first width w1, and a first thickness t1. The second pocket 814 may have a second length l2, a second width w2, and a second thickness t2. In some embodiments, the second length l2 may be equal to the first length l1. The first length l1 may be in the range of 0.5 mm to 2 mm. The second width w2 may be greater than the first width w1. The second thickness t2 may be greater than the first thickness t1. As illustrated, each of the first pocket 812 and the second pocket 814 may be cuboid shaped.

In some embodiments, the housing 840 may have a first portion 842 enclosing the first contact portions 902 of the pair of conductive elements 832A and 832B and the first mounting ends 910 of the first cable 710, and a second portion 844 enclosing the second contact portions 904 of the pair of conductive elements 832A and 832B and the second mounting ends 920 of the second cable 720.

Referring to FIG. 7, the conductive layer 730 may be conformably applied on the housing 840 and/or ends of the first cable 710 and the second cable 720. Conformal application of the conductive layer enables the amount of housing in each portion of the cable connector to establish the separation between signal conductors within the cable coupler and the ground layer, which is a parameter controlling impedance. To provide uniformity of impedance along the length of the cable coupler, the housing may have a different outer perimeter in different portions. As illustrated, for example, in FIG. 9, the perimeter of the housing is larger around the second contact portion 904 than around the first contact portion. In this example, the outer perimeter around the intermediation portion 906 is the same as around the first contact portion. In other examples, however, the perimeter of the housing may be different around each portion. Moreover, as also shown in FIG. 9, variations in the outer surface of the housing track variations in the outer edges of the conductive elements. As the distance from the centerline of the cable coupler to an outer edge of each conductive, the distance from the centerline to the outer surface of the housing similarly varies. To provide a generally uniform separation between the outer edges of the conductive elements and the surface of the housing, there may be tapered regions such as tapered regions 950, 952 or 954 at transitions between portions of the conductive elements.

As illustrated, the conductive layer 730 may have a first portion 732 conformably applied on the housing 840, a second portion 734 conformably applied on an end of the first cable 710, and a third portion 736 conformably applied on an end of the second cable 720. The second portion 734 may conform to a perimeter of the first cable 710 at which the cable shield has been exposed by removing a length of the cable jacket so at to electrically connect to a shield of the first cable 710 (e.g., shield 314 in FIG. 5). The third portion 736 may conform to a perimeter of the second cable 720 where the shield of that cable has been exposed so at to electrically connect to a shield of the second cable 720.

One or more parameters of the cable coupler may be selected in each portion of the cable coupler (e.g., the first contact portion, the second contact portion and the intermediate portion) to provide a desired impedance in each portion. The impedance may be, for example, within +/−3% or +/−2% or +/−1% of 95 Ohms, or 85 Ohms, 100 Ohms or 120 Ohms in some examples. Parameters that may be selected to achieve a desired impedance in each portion may include: the dimensions of the conductive elements, including those indicated in FIG. 9 and/or the width of the conductive element in the plane illustrated in FIG. 9 or the thickness perpendicular to the plane illustrated in FIG. 9, the thickness of the housing around the conductive elements (which sets the separation to ground applied as a conformal layer on the exterior of the housing) and/or dielectric constant of the housing in each portion, including of any windows therein, which may be filled with air or other material with a dielectric constant different than the rest of the housing.

A method of interconnecting the first cable 710 and the second cable 720 may include providing the pair of conductive elements 832A and 832B, forming the housing 840 to at least partially enclose the pair of conductive elements 832A and 832B, and applying the conductive layer 730 on the housing 840 by, for example, heat shrink tubing or PVD or other plating or coating technology. For application via heat shrink tubing, a tube with a conductive inner coating and/or made of a conductive material may be threaded over one of the cables. After that cable, and optionally a second cable, is terminated to a contact portion of the cable coupler and a housing applied to the cable coupler, that tube may be slide over the housing, while partially overlapping one or both of the cable ends. Heat may then be applied to heat the tubing. An example of a heat shrink tube is CHO-SHRINK electrically conductive heat shrink tubing, which is commercially available from Parker Hannifin Corp.

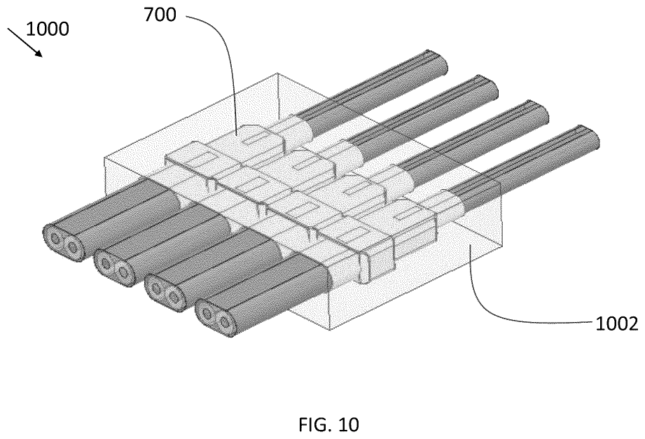

In some embodiments, a plurality of cable couplers 700 may be grouped together. The cable couplers of the group may be connected to each other or may be held by a common support member so as to form a cable coupler assembly. In the example illustrated, a support member is molded over the group. An overmolded support member may additionally provide strain relief for the cables of the assembly. FIG. 10 shows a perspective view of such a cable assembly 1000 having a plurality of cable couplers 700 disposed in an array, with a support member 1002 shown in phantom.

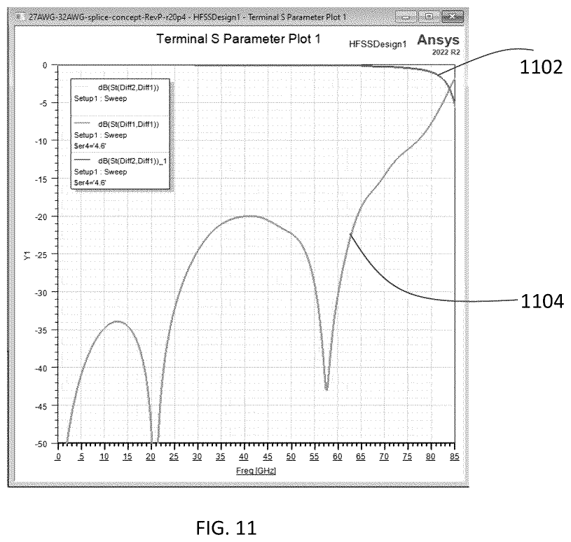

FIG. 11 is a simulated plot of S-parameters as a function of the frequency of signals transmitted through the cable coupler 700. As illustrated, the insertion loss 1102, which may indicate a ratio of an input power to a transmitted power, stays linear and close to 0 dB up to 65 GHz. The return loss 1104, which may indicate a ratio of a signal power injected from a source to the amount that is returned or reflected back toward the source, stays below −20 dB until 65 GHz. These results show that the cable coupler 700 can provide high signal integrity up to very high frequencies.

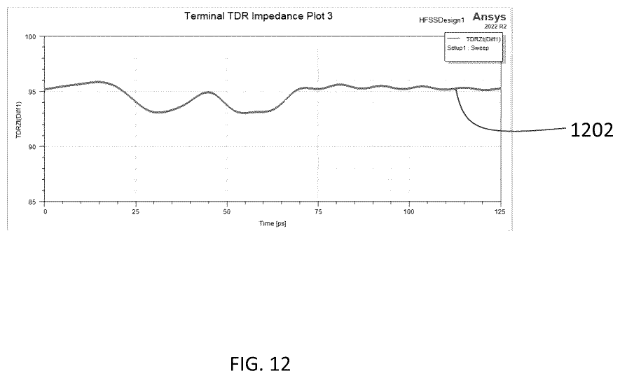

FIG. 12 is a plot of Time Domain Reflectometer (TDR) impedance as a function of time when a signal is transmitted through the cable coupler 700. As illustrated, the TDR impedance, which may indicate discontinuities along a transmission line, is substantially consistent over time, which indicates impedance change as a function of distance through the cable coupler. In this example, the impedance changes less than about +/−2 Ohms, which is about +/−2% along the length of the cable coupler. This plot further indicates that the cable coupler 700 may not have an appreciable effect on electrical properties along signal transmission paths over time.

Having thus described several aspects of cable assemblies, it is to be appreciated that various alterations, modifications, and improvements will readily occur to those skilled in the art.

For example, a coupler with a pair of conductive elements in an edge-to-edge configuration was pictured. It should be appreciated that a pair of conductive elements may broadside coupled over some or all of the length of the conductive elements. For example, the intermediate portions 906 of the pair may be broadside coupled, which may provide desired coupling between the pair.

As another example, the illustrated cable coupler is configured to provide a uniform impedance, which may be appropriate for coupling two cables with the same impedance. In other examples, the coupled cables may have different impedances, and the intermediate portion of the cable coupler may provide a smooth impedance transition by varying one or more of the properties described herein along the length of the intermediate portion.

As yet another example, a cable connector was illustrated in connection with a board connector and a cable connector of a specific configuration. Cable couplers as described herein may be used with connectors of other configurations or, in some examples, without any connector. In some examples, a cable assembly may be formed with a pressure mount connector terminating multiple cables. A pressure mount connector may be mated to a substrate by pressing contacts of the connector against pads on the substrate, without the use of a separate board connector.

Further, a cable coupler assembly was illustrated in which multiple cable couplers were held together in a rectangular array. The cable couplers may be positioned in an array of other configurations. As one example, the cable couplers may be arranged in multiple rows in which adjacent rows are offset in the row direction. Alternatively, some or all of the cable couplers may be used without being assembled into an assembly.

Such alterations, modifications, and improvements are intended to be part of this disclosure, and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used, should be understood to control over dictionary definitions, definitions in documents incorporated by reference, and/or ordinary meanings of the defined terms.

Numerical values and ranges may be described in the specification and claims as approximate or exact values or ranges. For example, in some cases the terms “about,” “approximately,” and “substantially” may be used in reference to a value. Such references are intended to encompass the referenced value as well as plus and minus reasonable variations of the value. For example, a phrase “between about 10 and about 20” is intended to mean “between exactly 10 and exactly 20” in some embodiments, as well as “between 10 ±d1 and 20±d2” in some embodiments. The amount of variation d1, d2 for a value may be less than 5% of the value in some embodiments, less than 10% of the value in some embodiments, and yet less than 20% of the value in some embodiments. In embodiments where a large range of values is given, e.g., a range including two or more orders of magnitude, the amount of variation d1, d2 for a value could be as high as 50%. For example, if an operable range extends from 2 to 200, “approximately 80” may encompass values between 40 and 120 and the range may be as large as between 1 and 300. When only exact values are intended, the term “exactly” is used, e.g., “between exactly 2 and exactly 200.” The term “essentially” is used to indicate that values are the same or at a target value or condition to within ±3%.

The term “adjacent” may refer to two elements arranged within close proximity to one another (e.g., within a distance that is less than about one-fifth of a transverse or vertical dimension of a larger of the two elements). In some cases there may be intervening structures or layers between adjacent elements. In some cases adjacent elements may be immediately adjacent to one another with no intervening structures or elements.

The indefinite articles “a” and “an,” as used in the specification and in the claims, unless clearly indicated to the contrary, should be understood to mean “at least one.”

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of”or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as

“comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed is:

1. A cable coupler, comprising:
a pair of conductive elements, each of the pair of conductive elements comprising a first contact portion, a second contact portion opposite the first contact portion, and an intermediate portion between the first contact portion and the second contact portion;
a cable comprising a pair of wires, each of the pair of wires comprising a mounting end disposed between the pair of conductive elements and attached to the first contact portion of a respective one of the pair of conductive elements; and
a housing holding the pair of conductive elements, the housing comprising a first material having a first dielectric constant, and a second material disposed between the mounting ends of the pair of wires of the cable, the second material having a second dielectric constant less than the first dielectric constant.

2. The cable coupler of claim 1, wherein:
the second material is air.

3. The cable coupler of claim 1, wherein:
the second material extends along the mounting end of the wire of the cable by a length that is in a range of 0.5 mm to 2 mm.

4. The cable coupler of claim 1, comprising:
a conductive layer bounding the housing.

5. The cable coupler of claim 1, wherein, for the pair of conductive elements:
the first contact portions are separated from each other by a first distance;
the second contact portions are separated from each other by a second distance; and
the second distance is greater than the first distance.

6. The cable coupler of claim 5, wherein, for the pair of conductive elements:
the intermediate portions are separated from each other by a third distance; and
the third distance is less than the first distance.

7. The cable coupler of claim 6, wherein:
the second material has a width substantially equal to the third distance.

8. The cable coupler of claim 1, wherein, for the pair of conductive elements:
the first contact portions comprise first edges facing each other;
the second contact portions comprise second edges facing each other;
the intermediate portions comprise third edges facing each other;
the first edges are offset from respective third edges by a first width;
the second edges are offset from respective third edges by a second width; and
the second width is greater than the first width.

9. The cable coupler of claim 8, wherein:
the mounting ends of the pair of wires of the cable are welded to the first edges of the first contact portions of respective ones of the pair of conductive elements.

10. The cable coupler of claim 9, wherein:
the cable is a first cable; and
the cable coupler comprises a second cable comprising a pair of wires, each of the pair of wires comprising a mounting end disposed between the pair of conductive elements and attached to the second edge of the second contact portion of a respective one of the pair of conductive elements.

11. The cable coupler of claim 10, wherein:
the second material of the housing is also disposed between the mounting ends of the pair of wires of the second cable.

12. A cable coupler comprising:
at least one conductive element, each of the at least one conductive element comprising a first contact portion, a second contact portion opposite the first contact portion, and an intermediate portion between the first contact portion and the second contact portion;
a housing at least partially enclosing the at least one conductive element; and
a conductive layer conformably applied on the housing.

13. The cable coupler of claim 12, wherein:
the at least one conductive element is a pair of conductive elements; and
the cable coupler further comprises:
a first cable comprising a pair of first wires, each of the pair of first wires comprising a first mounting end disposed between the pair of conductive elements, the first mounting ends of the pair of first wires attached to respective ones of the first contact portions of the pair of conductive elements; and
a second cable comprising a pair of second wires, each of the pair of second wires comprising a second mounting end disposed between the pair of conductive elements, the second mounting ends of the pair of wires attached to respective ones of the second contact portions of the pair of conductive elements.

14. The cable coupler of claim 13, wherein:
the conductive layer is electrically connected to shields of the first and second cables.

15. The cable coupler of claim 13, wherein:
the housing comprises a first pocket disposed between the first mounting ends of the first cable and a second pocket disposed between the second mounting ends of the second cable; and
the first pocket and second pocket have a smaller dielectric constant than rest of the housing.

16. The cable coupler of claim 15, wherein:
the first pocket and second pocket are filled with air.

17. The cable coupler of claim 15, wherein:
the first pocket and second pocket have different dielectric constants.

18. The cable coupler of claim 15, wherein:
the first pocket has a first width and a first thickness;
the second pocket has a second width and a second thickness;
the second width is greater than the first width; and
the second thickness is greater than the first thickness.

19. The cable coupler of claim 13, wherein:
the housing comprises a first portion enclosing the first contact portions of the pair of conductive elements and the first mounting ends of the first cable, and a second portion enclosing the second contact portions of the pair of conductive elements and the second mounting ends of the second cable; and
the second portion of the housing is wider and thicker than the first portion of the housing.

20. A cable assembly, comprising:
a plurality of cable couplers, each of the plurality of cable couplers comprising:
at least one conductive element, each of the at least one conductive element comprising a first contact portion, a second contact portion opposite the first contact portion, and an intermediate portion between the first contact portion and the second contact portion; and
a housing at least partially enclosing the at least one conductive element;
an electrical connector comprising a plurality of conductive elements, each of the plurality of conductive elements comprising a mating end, and a mounting end opposite the mating end; and
a plurality of cables, each of the plurality of cables comprising at least one wire, each of the at least one wire comprising a first mounting end and a second mounting end opposite the first mounting end, wherein, for each of the plurality of cables:
the first mounting end of the at least one wire is attached to respective first contact portion of the at least one conductive element of a respective one of the plurality of cable couplers; and
the second mounting end of the at least one wire is attached to respective mounting end of respective conductive element of the plurality of conductive elements of the electrical connector.

21. The cable assembly of claim 20, wherein:
the plurality of cable couplers are aligned in a plurality of rows; and
for each row, the cable couplers have a center-to-center distance no greater than 2.4 mm.

22. The cable assembly of claim 21, wherein:
the cable couplers in adjacent rows are aligned and have a center-to-center distance no greater than 2.0 mm.

23. The cable assembly of claim 20, wherein:
the plurality of cables are a plurality of first cables, each of the plurality of first cables comprises at least one wire of a first diameter; and
the cable assembly comprises a plurality of second cables, each of the plurality of second cables comprises at least one wire of a second diameter greater than the first diameter, each of the at least one wire of the second diameter comprises a first mounting end attached to respective second contact portion of the at least one conductive element of a respective one of the plurality of cable couplers.
